(19) United States
(12) Patent Application Publication
(10) Pub. No.: US 2024/0215553 A1
(43) Pub. Date: Jul. 4, 2024

(54) ARTIFICIAL FISH REEF, METHOD FOR FORMING ARTIFICIAL FISH REEF, AND SYSTEM FOR FORMING ARTIFICIAL FISH REEF

(71) Applicant: OHGI TECHNOLOGICAL CREATION CO., LTD., Otsushi, Shiga (JP)

(72) Inventors: Takehiko OHGI, Otsu-shi, Shiga (JP); Hirokazu MIYAJIMA, Ritto-shi, Shiga (JP); Eiji TANAKA, Takamatsu-shi, Kagawa (JP); Naoki KUROKAWA, Kyoto-shi, Kyoto (JP); Norio NISHINO, Kyoto-shi, Kyoto (JP)

(21) Appl. No.: 17/615,415

(22) PCT Filed: May 14, 2021
(86) PCT No.: PCT/JP2021/018422

§ 371 Date: Mar. 12, 2024

(51) Int. Cl. A01K 61/70; B09B 3/40; B09B 101/05

(52) U.S. Cl. CPC A01K 61/70; B09B 3/40; B09B 2101/05

(57) ABSTRACT

An artificial fish reef using a vehicle body made of steel plate of a discarded vehicle as an artificial-fish-reef outer shell portion, the artificial fish reef includes the artificial-fish-reef outer shell portion and a carbide which is generated by using interior and exterior materials which are provided to be attendant on the vehicle body as a raw material.

### TECHNICAL FIELD

The present invention relates to an artificial fish reef, a method for forming thereof, and a system for forming the artificial fish reef.

### BACKGROUND ART

An artificial fish reef is a fish reef which is artificially installed underwater for growth, propagation or the like of fish and shellfish or seaweed; for instance, the one which uses a concrete block, a fishing boat or the like has been variously proposed or performed. Patent Literature 1 discloses an art in which a whole scrapped fishing vessel made of FRP is entirely carbonized and is utilized as the artificial fish reef.

Utilization of the scrapped vessel as the artificial fish reef is expected to solve a problem of conventional vessel scrapping treatment which has required much labor and expense for dismantling a ship hull, separating and removing a valuable component or an illegal component, crushing a dismantlement piece or the like.

A carbide which is generated by heating treatment of a resin component which is contained in the main body of the fishing vessel made of FRP, interior and exterior materials of the scrapped vessel contributes to growth and propagation of fish and shellfish or seaweed and to water purification underwater.

### CITATION LIST

### Patent Literature

Patent Literature 1: Japanese Patent No. 3758908

### SUMMARY

### Technical Problem

When GFRP, i.e., glass fiber reinforced plastic, which is the main body of the fishing vessel made of FRP is heated in an oxygen-free condition, the resin component which is contained in the main body is carbonized by pyrolysis and becomes a FRP carbonized material in which the carbide adheres to periphery of glass fiber. The FRP carbonized material forms an artificial-fish-reef outer shell portion of the artificial fish reef.

However, the FRP carbonized material which is obtained by heating treatment contains glass as a main component and has low strength. Further, the main body has been deteriorated by ultraviolet irradiation or exposure to seawater during long time use as the fishing vessel and is incapable of keeping a shape of the main body undersea; therefore, the main body is not utilized as the artificial fish reef in fact.

The present invention is proposed in view of the above-mentioned problems. An object of the present invention is to provide the artificial fish reef which keeps an original shape over a prolonged period underwater and effectively supplies undersea life with nourishment, and is to provide a method for forming the artificial fish reef and a system for forming the artificial fish reef which easily forms the artificial fish reef as mentioned above.

### Solution to Problem

An artificial fish reef of one embodiment of the present invention using a vehicle body made of steel plate of a discarded vehicle as an artificial-fish-reef outer shell portion is characterized in that the artificial fish reef is provided with the artificial-fish-reef outer shell portion and a carbide which is generated by using interior and exterior materials which are provided to be attendant on the vehicle body as a raw material.

A method for forming an artificial fish reef of one embodiment of the present invention is characterized in that the method is configured by forming the artificial fish reef which has an artificial-fish-reef outer shell portion and a carbide by heating a discarded vehicle in a carbonization furnace. The artificial-fish-reef outer shell portion is configured by a vehicle body made of steel plate of the discarded vehicle. The carbide is generated so as to be attendant in and out of the artificial-fish-reef outer shell portion by pyrolyzing interior and exterior materials which are provided to be attendant on the vehicle body.

A system for forming an artificial-fish-reef of one embodiment of the present invention for providing an artificial fish reef which has an artificial-fish-reef outer shell portion and a carbide by heating a discarded vehicle in a carbonization furnace, the artificial-fish-reef outer shell portion being configured by a vehicle body made of steel plate of the discarded vehicle, the carbide being generated so as to be attendant in and out of the artificial-fish-reef outer shell portion by pyrolyzing interior and exterior materials which are provided to be attendant on the vehicle body, the system is characterized in that the carbonization furnace is arranged in a carbonization equipment, wherein heating treatment is performed with a time difference to a plurality of discarded vehicles and cooling treatment of the artificial fish reef which is provided by the heating treatment is performed in the carbonization equipment.

### Advantageous Effects of Invention

Configured as above, the artificial fish reef of the embodiment of the present invention keeps an original shape over a prolonged period underwater and effectively provides undersea life with nourishment. The method for forming the artificial fish reef of the embodiment of the present invention is processed as above and thereby the artificial fish reef is easily and effectively formed. The system for forming the artificial fish reef of the embodiment of the present invention is configured as mentioned above and thereby a number of artificial fish reefs are effectively formed.

### BRIEF DESCRIPTION OF DRAWINGS

FIG. 1 is a view illustrating the method for forming the artificial fish reef of one embodiment of the present invention.

FIG. 2 is an external schematic view of the carbonization furnace used for the method for forming the artificial fish reef and a peripheral device of the carbonization furnace.

FIG. 3 is a longitudinal sectional view schematically illustrating the internal structure of the carbonization furnace.

FIG. 4 is an external schematic view of another carbonization furnace used in the method for forming the artificial fish reef and a peripheral device of the carbonization furnace.

FIG. 5 is a schematic plane view illustrating one example of the system for forming an artificial fish reef of the present invention.

FIG. 6 is a longitudinal sectional view schematically illustrating another example of the system for forming the artificial fish reef of the present invention.

FIG. 7 is a longitudinal sectional view schematically illustrating another example of the system for forming the artificial fish reef of the present invention.

### DESCRIPTION OF EMBODIMENTS

An embodiment of the present invention is explained below with reference to the drawings. First, an outline flow of a method for forming an artificial fish reef of the embodiment is described.

In the method for forming the artificial fish reef of the embodiment to be explained below, a discarded vehicle 20 is heated in a carbonization furnace 30, and thereby forming an artificial fish reef 10 which has an artificial-fish-reef outer shell portion 11 configured by a vehicle body 21 made of steel plate of the discarded vehicle 20 and has a carbide 12 generated so as to be attendant in and out of the artificial-fish-reef outer shell portion 11 by pyrolyzing interior and exterior materials 23, 22 which are provided to be attendant on the vehicle body 21.

In the carbonization furnace 30 used in the embodiment to be explained below, a heating means is the one by superheated steam but is not limited to the one; the carbonization furnace 30 can be an electric heating furnace or a gas furnace or further can be the one of which system uses microwave.

First of all, a valuable component or an unnecessary component for a fish reef is desirable to be removed before performing heating treatment of the discarded vehicle 20. These components include, for instance, glass, an electrical component, an engine, a shaft, a transmission component, other driving components, a battery, and the like. Moreover, a metallic member or the like which is unnecessary for the fish reef is desirable to be removed as much as possible. Needless to say, if there is a component out of the above components which is difficult to be removed, the component can be remained. Furthermore, such a component which generates poisonous gas by heating treatment is desirable to be removed.

A tire 24 can remain attached but can be removed together with a wheel as the valuable component. As mentioned below, the tire 24 which is removed beforehand can be heated together with the vehicle body 21 in the carbonization furnace 30.

Being a rubber product, the tire 24 is carbonized and further has a high yield of 48%, and much carbon black is obtained by pyrolysis. Therefore, the tire 24 is also expected to be reutilized as activated carbon by being removed and carbonized apart from formation of the artificial fish reef 10.

The tire 24 contains sulfur as a component and a sulfur-based gas is generated by pyrolysis. By arranging powdery plaster on the surface of the tire 24 before heating, a sulfur component is absorbed in plaster and solidified. Thereby, the sulfur component is easily separated from a rubber component.

The discarded vehicle 20 from which the valuable component or the like is removed includes the vehicle body 21 made of steel plate, the exterior material 22, and the interior material 23. The exterior material 22 includes a coating 22a made from resin which adheres onto the surface of the vehicle body 21, a lamp cover 22b, the tire 24 or the like. The interior material 23 includes a seat, a dashboard, a steering wheel, an air bag, a center console, a ceiling, a window frame, a floor mat, an internal coating or the like.

The carbonization furnace 30 is a device which heats and pyrolyzes a carbon compound such as an organic compound in a state in which oxygen is blocked. By pyrolysis, some of the carbon compound is gasified and some of the carbon compound is carbonized and reduced in volume. Accordingly, by heating the discarded vehicle 20 in the carbonization furnace 30, the carbon compound such as synthetic resin of the coating 22a, the tire 24, the interior material 23 which are attendant on the vehicle body 21 partially remains as the carbide 12, i.e., carbon, by pyrolysis in the carbonization furnace 30 at a predetermined temperature.

Thus, by performing pyrolysis treatment of the discarded vehicle 20 under an oxygen-free state or an almost similar state, generation of carbon dioxide which is largely generated when incineration treatment, i.e., conventional vehicle discarding treatment, is performed is suppressed.

On the other hand, the vehicle body 21 made of steel plate or the interior and exterior materials 23, 22 made of metal hardly changes the shape even by heating at about 600 degrees Celsius in the carbonization furnace 30 and an outer shape by the vehicle body 21 is generally retained.

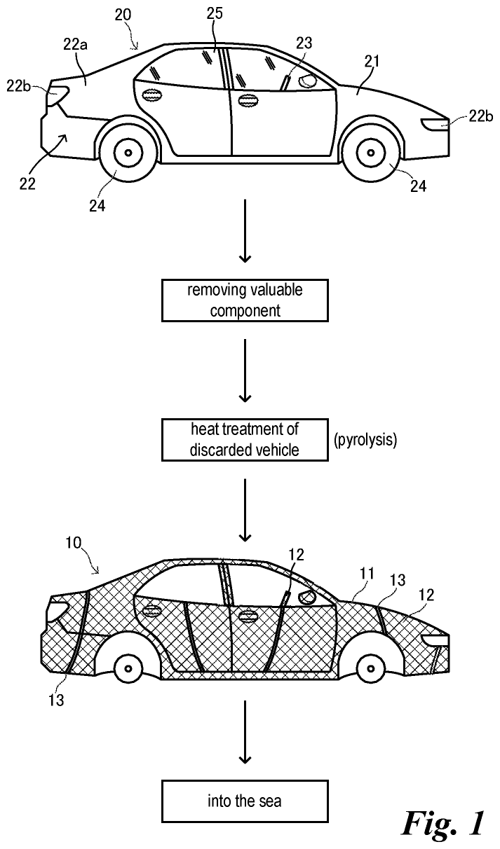

By heating the discarded vehicle 20 from which the valuable component is removed as mentioned above, the artificial fish reef 10 in which the vehicle body 21 is the artificial-fish-reef outer shell portion 11 is formed as illustrated in FIG. 1. The carbide 12 which is generated by the pyrolysis of the coating 22a adheres to an outer surface of the artificial-fish-reef outer shell portion 11 in such a state that a crack 13 partially occurs. In FIG. 1, the carbide 12 made by the coating 22a is illustrated with cross hatching.

The interior material 23 made of resin (for instance, the steering wheel) remains as the carbide 12 in an interior space of the vehicle body 21 by the pyrolysis. Thus, the carbide 12 which is generated by using the interior and exterior materials 23, 22 which are made of resin or the like and are attendant on the vehicle body 21 of the discarded vehicle 20 as a raw material is in a state to be attendant in and out of the artificial-fish-reef outer shell portion 11.

Out of the unnecessary components for the fish reef, a component such as the electrical component which was unremovable beforehand is removed after the heating treatment. For example, as for a wire harness, a resin part is pyrolyzed by the heating treatment and then is carbonized and gasified; therefore, a wire made of metal remains but the wire is easily removed.

As for the tire 24, even when carbonized together with the vehicle body 21 of the discarded vehicle 20 or even when carbonized separately, most of the wire made of metal becomes easily eliminated by a carbonization.

When used as a part of the artificial fish reef 10, the carbide 12 of the tire 24 is carbonized together with the vehicle body 21 in a state of being separated from the vehicle body 21 and of being arranged with powdery plaster on the surface of the tire 24. In such a case, there is no need to crush the tire 24 to pieces or eliminate the wire from the tire 24 beforehand; an original shape of the tire 24 is generally kept after carbonization. The wheel can be removed as the valuable component beforehand or can be utilized as the part of the artificial fish reef 10 by being carbonized in a state to be integrated with the tire 24.

The artificial fish reef 10 which is formed as mentioned above of the discarded vehicle 20 functions as the fish reef by being sunk in the sea. Namely, the carbide 12 which is porous and remains in and out of the artificial-fish-reef outer shell portion 11 becomes a dwelling for a microorganism in the sea; the microorganism becomes a nutrient and seaweed such as kombu or fish and shell-fish grows. Specifically, the carbide 12 which is formed by carbonizing the coating 22a adheres to the outer surface of the artificial-fish-reef outer shell portion 11 and thereby seaweed grows so as to cover the artificial fish reef 10. If there is the carbide 12 of the tire 24, the carbide 12 of the tire 24 is sunk in the sea as the part of the artificial fish reef 10 in the vicinity of the one by the vehicle body 21 while the carbide 12 of the tire 24 keeps the shape of the tire 24 or can be in a state of accompanying the wheel.

Having the vehicle body 21 made of steel plate as a base, the artificial-fish-reef outer shell portion 11 emits iron, i.e., bivalent iron and trivalent iron, underwater. Bivalent iron is an essential element for growth of a living being and contributes to growth of various undersea lives. Trivalent iron combines with fulvic acid and forms fulvic acid iron; the fulvic acid iron is reduced to bivalent iron underwater.

When seaweed grows by bivalent iron, photosynthesis is activated and the absorption amount of carbon dioxide increases. Thus, by installing the artificial fish reef 10 in the sea, carbon dioxide decreases.

In recent years, iron which is flown into a river is decreasing owing to decrease in leaf mold associated with decrease in a board leaf tree in a domestic forest; as a result, iron in the sea is also decreasing. Therefore, the microorganism such as plankton decreases and a marine ecosystem tends to be disordered.

By incineration treatment of the discarded vehicle 20 which has been performed conventionally, carbon dioxide emission is estimated as follows, for instance. Such estimation is based on a research report of carbon dioxide emission by City of Mizunami in fiscal 2011.

Specifically, carbon dioxide emission is calculated by a formula for computation as follows.

Carbon dioxide emission is obtained by Formula: the amount of incineration of general waste (vehicle weight (ton)) multiplied by a rate of a combustible (in case of plastic, 1) multiplied by a rate of plastic multiplied by a carbon dioxide emission coefficient.

Assuming that an average weight of the discarded vehicle 20 is 1.35 tons, a rate of a member made of plastic is ten percent of the weight of the discarded vehicle 20, and the carbon dioxide emission coefficient is 2.69 (an example of City of Mizunami), carbon dioxide emission per vehicle is

1.35 multiplied by 1 multiplied by 0.1 multiplied by 2.69 equals to 0.363 tons.

Assuming that the number of annual domestic discarded vehicles is about 3.3 million, annual carbon dioxide emission is

0.363 multiplied by 3,300,000 equals to 1,197,900 tons.

Thus, by the incineration treatment of the discarded vehicle 20, 1.2 million tons of carbon dioxide is estimated to be emitted per year.

Another search report as follows has been reported, which relates to a coating material out of synthetic resin which is used for a vehicle and is based on the number of domestic discarded vehicles in fiscal 2016.

A sum of the weight of the coating material, which is used for a new vehicle or repair, of the number of annual discarded vehicles, 4.65 million, is 247,000 tons and annual carbon dioxide emission is calculated to be 776,000 tons.

That is to say, in the incineration treatment, only about the coating material, approximately 0.8 million tons of carbon dioxide is emitted per year.

Therefore, if the above-mentioned carbonization by the heating treatment of the discarded vehicle 20 is promoted, according a figure on the research in fiscal 2011, carbon dioxide emission is reduced by up to one million two thousand tons per year. Although the figure is less compared to that of total domestic carbon dioxide emission, an effect such as carbon dioxide absorption is also obtained by the artificial fish reef 10 which is formed by the heating treatment of the discarded vehicle 20, the formation of the artificial fish reef 10 by the discarded vehicle 20 greatly contributes to reduction of carbon dioxide emission, i.e., reduction of greenhouse gas.

Because the artificial-fish-reef outer shell portion 11 is made of steel plate, an outer shape thereof is kept without mostly loosing its shape over the prolonged period in the sea. Therefore, the artificial fish reef 10 which is obtained by heating in the above-mentioned method is usable over the prolonged period.

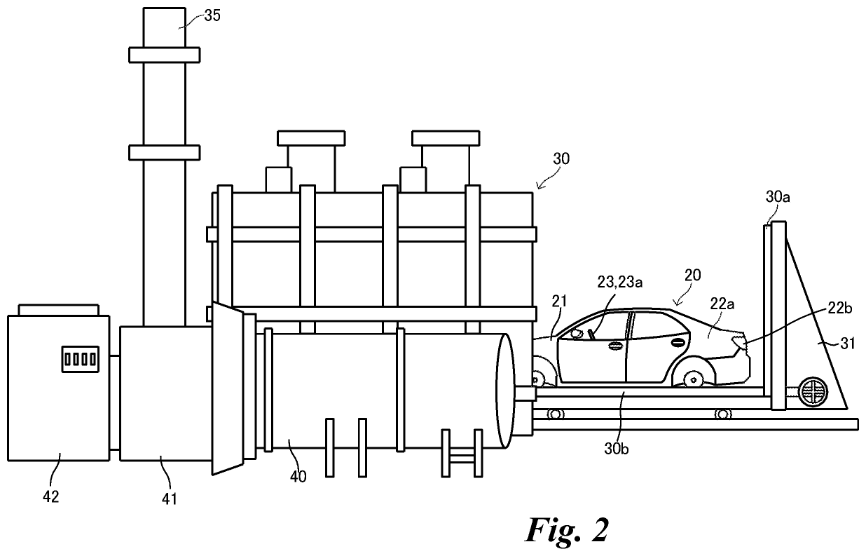

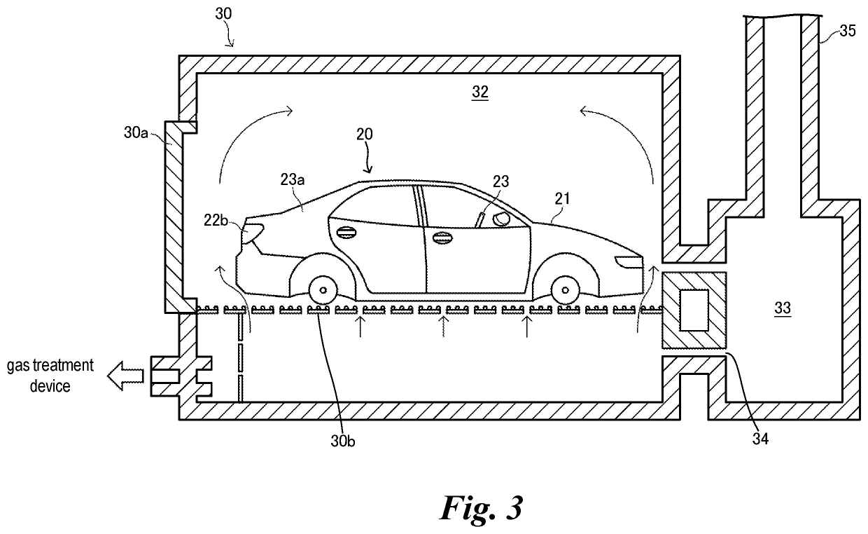

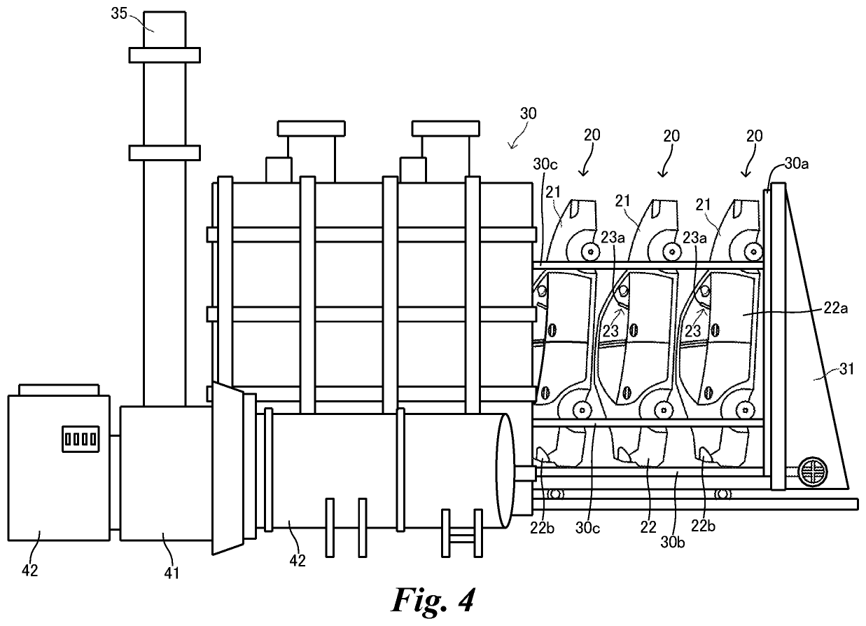

Next, details of the heating treatment of the discarded vehicle 20 by the carbonization furnace 30 are described below with reference to FIGS. 1 to 4. FIG. 2 is an external schematic view of the carbonization furnace 30 and a peripheral device thereof. FIG. 3 is a longitudinal sectional view schematically illustrating an internal structure of the carbonization furnace 30. FIG. 4 is an external schematic view of another carbonization furnace 30 and a peripheral device thereof.

The carbonization furnace 30 is a batch type which heats by using superheated steam and is configured by including a placement portion 30b of a roller type and a sealing door 30a. The placement portion 30b and the sealing door 30a are integrated with each other and are carried in and out to an internal heating chamber 32 of the carbonization furnace 30 by a carriage 31 in such a state that the discarded vehicle 20 is placed on the placement portion 30b.

The carbonization furnace 30 illustrated in FIG. 4 is configured to carbonize a plurality of discarded vehicles 20 and therefore the carbonization furnace 30 is large in size. The discarded vehicle 20 is vertically disposed so as to align the longitudinal direction thereof with the vertical direction; a plurality of discarded vehicles 20 are arranged in the carbonization furnace 30 so as to line up in the carry-in/out direction. A frame portion 30c is fixed to the sealing door 30a in order to vertically dispose the discarded vehicle 20 in a stable manner.

The sealing door 30a is used for sealing the internal heating chamber 32 of the carbonization furnace 30; as for a packing which is used therefor, expanded graphite which hardly deforms by heating is preferable to be used instead of rubber.

Although the carbonization furnace 30 in FIG. 4 has a different dimension from the carbonization furnace 30 in FIG. 2, the internal structure including a second combustion chamber 33 and the mechanism are similar and therefore an attachment of a schematic view of the internal structure of the carbonization furnace 30 of FIG. 4 is omitted.

The carbonization furnace 30 is coupled to a superheated steam generation device (not illustrated) which is connected to a boiler 42 and thereby is configured to supply superheated steam into the internal heating chamber 32 of the carbonization furnace 30. A temperature within the internal heating chamber 32 is kept approximately constant by convection of superheated stream.

The internal heating chamber 32 is communicated and connected to the second combustion chamber 33 through the gas flow passage 34. Dry distillation gas which is generated in the internal heating chamber 32 is guided to the second combustion chamber 33 and is heated/combusted thereat; while steam is discharged from an exhaust stack 35, exhaust gas is discharged from the carbonization furnace 30 after being utilized for heating the carbonization furnace 30, is detoxified by cooling and dedusting in a gas treatment device 40 which has a gas cooler 41, and is released to an atmospheric air.

The carbonization furnace 30 is capable of performing a plurality of temperature settings which are most suitable for carbonization and is capable of warming and heating up gradually to a set temperature. By the carbonization furnace 30, the internal heating chamber 32 is warmed and heated up to, for instance, 200 degrees Celsius and is maintained for a fixed time and the discarded vehicle 20 is carried therein; after that, the internal heating chamber 32 is warmed and heated up to from 350 degrees Celsius to 400 degrees Celsius in the oxygen-free state and is maintained for the fixed time; further after that, the internal heating chamber 32 is warmed and heated up to about 600 degrees Celsius and is maintained for the fixed time. Thus, by controlling the temperature in the internal heating chamber 32, the carbide 12 is obtained by various interior and exterior materials 23, 22.

In the carbonization furnace 30, by gradually heating several times from about 200 degrees Celsius, various interior and exterior materials 23, 22 are carbonized regardless of thermal plasticity or a thermosetting property. For instance, in a carbonization condition of EPDM, i.e., ethylene propylene diene rubber, to be described below, a carbonization temperature is about 500 degrees Celsius and a maintained time is about one hour.

By heating at a gradual temperature as mentioned above, various kinds of resin materials are carbonized at respective carbonization temperatures. Even by pyrolysis, because part of the resin material is likely to generate gas and fuse without being carbonized, a temperature control so as not to rapidly heat at a high temperature or the like is required. Particularly, the coating 22a is preferable to be carbonized so as not to fuse and run down from the surface of the vehicle body 21 and to be maintained in a state in which the carbide 12 adheres to the surface of the artificial-fish-reef outer shell portion 11.

As for the coating 22a of the vehicle body 21, acrylic resin or urethane resin is used for instance and further there are some cases where different kinds of things are coated in a plurality of layers but the coating 22a is carbonized by gradual heating.

If EPDM is used for the window frame or the steering wheel which is the interior material 23, those resin materials is carbonized by gradually heating at the carbonization temperature for each resin. According to an experiment, a yield of EPDM is about 48%.

Resin which is used for the interior and exterior materials 23, 22 includes acrylic resin, urethane resin, PET, EPDM, PA, PP, PE, alkyd resin, chlorinated polyolefin resin, silicon resin, epoxy resin, AS resin, ABS resin, polyvinyl chloride or the like.

In the carbonization furnace 30, when a gradual temperature rise control is performed, for instance, within a range of 200 degrees Celsius to 600 degrees Celsius, plenty of carbides 12 are obtained based on various kinds of synthetic resin as mentioned above.

Although the heating treatment can be performed from an ordinary temperature after the discarded vehicle 20 is carried into the internal heating chamber 32, preheating is preferable to be performed with nothing left in because it takes time to reach the high temperature if there is the discarded vehicle 20 in the internal heating chamber 32. For instance, the carbonization furnace 30 is heated beforehand with a burner or the like up to about 100 degrees Celsius to 200 degrees Celsius and after that the discarded vehicle 20 is carried into the carbonization furnace 30, thereby performing heating treatment more effectively.

Dry distillation gas which is generated by pyrolysis together with the carbide 12 can be utilized as thermal energy. Specifically, dry distillation gas is reutilized for a Stirling engine or a micro gas turbine which is capable of converting dry distillation gas to electricity. By such utilization of dry distillation gas, a running cost of the pyrolysis treatment is also reduced.

Needless to say, a generation oil is able to be generated by liquefying generated dry distillation gas. That is to say, chemical recycling in which synthetic resin is restored to a coal oil is achieved. The above-mentioned generation oil is used as fuel for an internal combustion engine such as a diesel engine, a reciprocating engine, a rotary engine or the like, fuel for other machinery, a boiler fuel, or power generation.

Thus, by heating the discarded vehicle 20, the artificial fish reef 10 is formed as mentioned above. Further, generation of carbon dioxide is suppressed because the heating treatment is the pyrolysis treatment. Carbon dioxide which is generated by the pyrolysis treatment can be reacted with hydrogen, thereby generating methane gas or methanol. Thus, a useful substance such as methane gas is separated and collected, and emission of carbon dioxide is reduced.

Until completion of forming the artificial fish reef 10 by the carbonization furnace 30 of the above-mentioned batch type, the heating treatment to the carbonization which includes preheating in advance with nothing left in the carbonization furnace 30 requires three to five hours, and cooling treatment for ejecting the artificial fish reef 10 requires one to two hours. Namely, one cycle for an operation of the carbonization furnace 30 requires a long time.

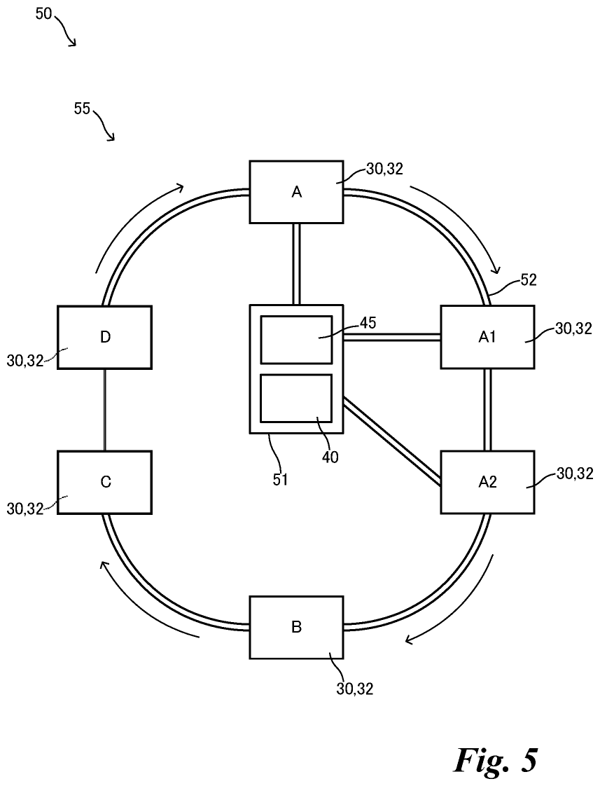

Because one cycle of forming the artificial fish reef 10 requires a long time as mentioned above, the artificial fish reef 10 can be formed by effectively utilizing the carbonization furnace 30 with systems and methods illustrated in FIGS. 5 to 7. All of the above-mentioned systems include a carbonization equipment 55 which heats a plurality of discarded vehicles 20 with a time difference and the cooling treatment is performed continuously and respectively to the heating treatments which are performed with the time difference.

In an artificial-fish-reef formation system 50 illustrated in FIG. 5, a plurality of carbonization furnaces 30 are installed in the carbonization equipment 55; a heat source 45 which includes the boiler 42 (refer to FIG. 2 etc.) and the superheated steam generation device (not illustrated) is installed as a common equipment 51 of a plurality of carbonization furnaces 30. As for the common equipment 51, a peripheral device such as the gas treatment device 40 other than the heat source 45 can be included as illustrated in FIG. 5.

In the artificial-fish-reef formation system 50 exemplified in FIG. 5, a plurality of carbonization furnaces 30 are installed around the heat source 45 so as to circulate and move on a rail 52 which is installed on a plane surface. In positions A, A1, A2, the carbonization furnace 30 is connected to the heat source 45; in a position B, the cooling treatment is performed for the carbonization furnaces 30 by leaving as it is; in a position C, the artificial fish reef 10 is ejected and preheating of the carbonization furnace 30 is performed after ejecting; in a position D, a new discarded vehicle 20 is carried in.

For instance, given that the carbonization furnace 30 stops at each position for about one hour, total three hours of heating treatment is performed to the discarded vehicle 20 per vehicle at the positions A, A1, A2; in the position B, the cooling treatment is performed for about one hour; in the position C, preheating is performed for one hour.

By the artificial-fish-reef formation system 50 as mentioned above, even when one cycle of forming the artificial fish reef 10 requires a long time, the carbonization equipment 55 is effectively operated; the artificial fish reef 10 is continuously formed and efficiency is achieved. By a time-difference operation of the carbonization furnace 30, gas is constantly generated and utilization of gas as thermal energy is continuously performed.

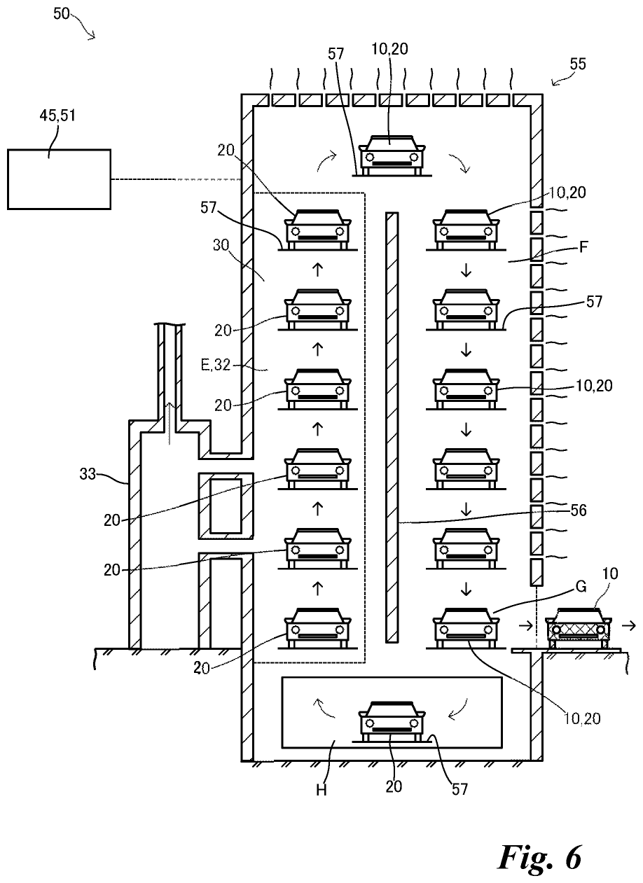

The artificial-fish-reef formation system 50 can be the one which has the carbonization equipment 55 illustrated in FIG. 6. The carbonization equipment 55 is a circulation type carbonization furnace of a tower type, and is made to house a plurality of discarded vehicles 20 therein so as to be circularly movable. The common equipment 51 such as the heat source 45 is installed at an appropriate position so as to be connectable to the internal heating chamber 32.

Inside the carbonization equipment 55, an area in which a plurality of discarded vehicle placement portions 57 line up in the vertical direction lines up in two rows in the traverse direction; the discarded vehicle placement portions 57 is provided one by one at upper and lower end portions; and the discarded vehicle placement portions 57 rotate and circulate. Out of two areas in the vertical direction, one area has a heating region E and the other area has a cooling region F. A heating region D is capable of housing six discarded vehicles 20 and communicates with the second combustion chamber 33. In the cooling region F, six discarded vehicles 20 (the artificial fish reefs 10) which are formed by the heating treatment are housed.

The heating region E and the cooling region F are divided by an adiabatic wall 56; in the cooling region F, air cooling is effectively performed by taking in air from outside through an airflow passage which is provided in an outer wall.

The discarded vehicle placement portions 57 can be the carbonization furnace 30 which individually corresponds to the discarded vehicle 20 or can be a gondola or the like in which the discarded vehicle 20 is loaded in an exposed state. In the former case, the heating treatment is performed in such a manner that the carbonization furnace 30 is connected to the heat source 45 in the heating region E; in the latter case, the carbonization equipment 55 is used as a huge carbonization furnace 30 and a plurality of discarded vehicles 20 are heated in the heating region E.

In the artificial-fish-reef formation system 50 illustrated in FIG. 6, the discarded vehicle 20 which is carried in a carry-in position H rotationally moves in clockwise rotation and is heated in the heating region E while rotating; the artificial fish reef 10 which is formed by the heating treatment rotationally moves upward and further is cooled while moving towards the cooling region F on the right, reaches a carry-out position G, and is carried out therefrom.

For instance, given that the discarded vehicle placement portion 57 stops at a predetermined position for one hour, the discarded vehicle 20 is heated for total six hours one by one in the heating region E and is carried out as the artificial fish reef 10 after seven hours of the cooling treatment.

By the artificial-fish-reef formation system 50, the artificial fish reef 10 is continuously formed and efficiency is achieved same as the system of FIG. 5. Further, gas is constantly generated and utilization of gas as thermal energy is continuously performed. Because the carbonization equipment 55 is the tower type, a vast site is not necessary to be used for forming a number of artificial fish reefs 10.

In the carbonization equipment 55 illustrated in FIG. 6, the adiabatic wall 56 is arranged between the heating region and the cooling region, and thereby the heating region and the cooling region are able to be lined up in a narrow vertically long space.

The circulation type carbonization furnace, i.e., the carbonization equipment 55, as illustrated in FIG. 6 can be the one which is capable of circulating and moving planarly.

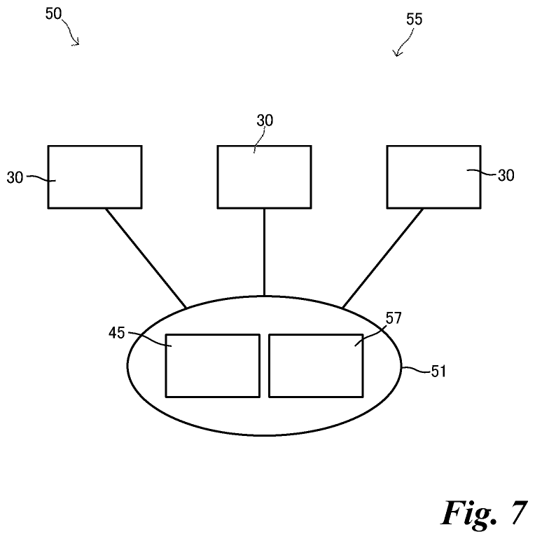

The cooling treatment of the systems in FIGS. 5 and 6 can be the one by water-cooling treatment or air-cooling treatment which uses a heat transfer device 58, referring to FIG. 7. The artificial-fish-reef formation system 50 illustrated in FIG. 7 includes three carbonization furnaces 30 and further includes the heat source 45 and the heat transfer device 58 as the common equipment 51.

In the artificial-fish-reef formation system 50 illustrated in FIG. 7, during the carbonization by the heating treatment in one carbonization furnace 30, the inside of the furnace is cooled by using the heat transfer device 58 in another carbonization furnace 30 in which carbonization treatment by the heating treatment is completed and the artificial fish reef 10 is formed; preheating before carrying in the discarded vehicle 20 is able to be performed in another carbonization furnace 30.

Thus, because preheating treatment, carbonization heating treatment, and the cooling treatment are performed in a cyclic manner in the three carbonation furnaces 30 one by one while shifting a time, a plurality of carbonization furnaces 30 are effectively utilized and an effective production of the artificial fish reef 10 is achieved.

### REFERENCE SIGNS LIST

10 artificial fish reef
11 artificial-fish-reef outer shell portion
12 carbide
13 crack
20 discarded vehicle
21 vehicle body
22 exterior material
22a coating
22b lamp cover
23 interior material
24 tire
25 glass
30 carbonization furnace
30a sealing door
30b placement portion
30c frame portion
31 carriage
32 internal heating chamber
33 second combustion chamber
34 gas flow passage
35 exhaust stack
40 gas treatment device
41 gas cooler
42 boiler
45 heat source
50 artificial-fish-reef formation system
51 common equipment
52 rail
55 carbonization equipment
56 adiabatic wall
57 discarded vehicle placement portion
58 heat transfer device

1. An artificial fish reef using a vehicle body made of steel plate of a discarded vehicle as an artificial-fish-reef outer shell portion, the artificial fish reef comprising:
the artificial-fish-reef outer shell portion; and
a carbide which is generated by using interior and exterior materials which are provided to be attendant on the vehicle body as a raw material.

2. The artificial fish reef according to claim 1,
wherein part of the carbide adheres to an outer surface of the artificial-fish-reef outer shell portion.

3. A method for forming an artificial fish reef, the method comprising:
forming the artificial fish reef having an artificial-fish-reef outer shell portion and a carbide by heating a discarded vehicle in a carbonization furnace, the artificial-fish-reef outer shell portion being configured by a vehicle body made of steel plate of the discarded vehicle, the carbide being generated so as to be attendant in and out of the artificial-fish-reef outer shell portion by pyrolyzing interior and exterior materials which are provided to be attendant on the vehicle body.

4. The method for forming an artificial fish reef according to claim 3,
wherein a valuable component is removed before performing heating treatment of the discarded vehicle.

5. The method for forming an artificial fish reef according to claim 3,
wherein part of the carbide adheres to a surface of the artificial-fish-reef outer shell portion.

6. The method for forming an artificial fish reef according to claim 3,
wherein the carbonization furnace warms and heats up gradually.

7. The method for forming an artificial fish reef according to claim 3,
wherein the carbonization furnace is a batch type and houses a plurality of discarded vehicles.

8. The method for forming an artificial fish reef according to claim 3,
wherein the carbonization furnace is arranged in a carbonization equipment, and
wherein the heating treatment is performed with a time difference to the plurality of discarded vehicles in the carbonization equipment and subsequently cooling treatment of the artificial fish reef which is performed by the heating treatment is performed.

9. A system for forming an artificial fish reef having an artificial-fish-reef outer shell portion and a carbide by heating a discarded vehicle in a carbonization furnace, the artificial-fish-reef outer shell portion being configured by a vehicle body made of steel plate of the discarded vehicle, the carbide being generated so as to be attendant in and out of the artificial-fish-reef outer shell portion by pyrolyzing interior and exterior materials which are provided to be attendant on the vehicle body, the system comprising:
the carbonization furnace being arranged in a carbonization equipment,
wherein heating treatment is performed with a time difference to the plurality of discarded vehicles and cooling treatment of the artificial fish reef which is provided by the heating treatment is performed in the carbonization equipment.

10. The system for forming an artificial fish reef according to claim 9,
wherein the carbonization equipment has a common heat source for heating the plurality of discarded vehicles.

11. The system for forming an artificial fish reef according to claim 9,
wherein the carbonization equipment has a common heat transfer device for cooling the plurality of discarded vehicles.

12. The system for forming an artificial fish reef according to claim 9,
wherein the carbonization equipment has a plurality of carbonization furnaces, and
wherein the plurality of carbonization furnaces are installed so as to circulate and move planarly.

13. The system for forming an artificial fish reef according to claim 9,
wherein the carbonization equipment is a circulation type equipment in which the plurality of discarded vehicles are housed to be circularly movable, is provided with a heating region and a cooling region inside thereof, and the artificial fish reef which is provided by the heating treatment performed at the heating region is configured to be movable to the cooling region by rotation.

14. The system for forming an artificial fish reef according to claim 13,
wherein the heating region and the cooling region are adjacent to each other and an adiabatic wall is arranged between both regions.
